(19) United States
(12) Patent Application Publication
(10) Pub. No.: US 2011/0000620 A1
(43) Pub. Date: Jan. 6, 2011

(54) Device for the Alignment of Labels in a Labelling Machine

(75) Inventors: Gerard Dijkstra, Marstrand (SE); Jonas Södergård, Goteborg (SE)

Correspondence Address: POTOMAC PATENT GROUP PLLC, P. O. BOX 270, FREDERICKSBURG, VA, 22404, US

(73) Assignee: AUTOLABEL AB, Göteborg (SE)

(21) Appl. No.: 12/867,953

(22) PCT Filed: Feb. 17, 2009
(86) PCT No.: PCT/SE2009/050170

§ 371 Date: Aug. 17, 2010

(30) Foreign Application Priority Data
Feb. 20, 2008 (SE) 0800386-5

(51) Int. Cl. B65C 9/42

(52) U.S. Cl. 156/361

(57) ABSTRACT

The invention relates to a device (1) of a machine (2) for outputting self-adhesive labels (3) from a reel (4), and that comprises a write head (5), as well as drive means for a label web (7), with the write head (5) movably mounted for widening a formed gap (8) through the machine (2) for pulling the label web (7) between the write head (5) and a drive platen (9) to a reeling reel. A sensor (11) formed of a transmitter (12) and a receiver (13) is arranged to sense inter-spaces at labels carried consecutively on the label web (7) by sensing the thickness differences of the label web (7) and of the labels (3) thereof carried on a bottom paper web. According to the invention, the sensor (11) is partible (12, 13).

The present invention relates to a device of a machine for outputting self-adhesive labels from a reel, and comprising a write head, as well as drive means for a label web, with the write head movably mounted for widening a formed gap through the machine for pulling the label web between the write head and a drive platen to a reeling reel, and that a sensor formed of a transmitter and a receiver is arranged to sense interspaces at labels carried consecutively on the label web by sensing the thickness differences of the label web and of the labels thereof carried on a bottom paper web.

Known devices of labelling machines are complicated both as regards the construction and the operation thereof. When it is desired to pull a new label web through the machine, when the previous label web has run out or if it for any other reason is desired to exchange a label web for a label web having different labels, e.g., having another size, colour, print, shape, etc., it has been needed to try to coax the free end of this label web inward past a fixed sensor in question, which is arranged to sense the position of the web upon start and the following feeding thereof through a labelling machine in question and the printing unit as well as output unit thereof for the application on intended objects or for manual picking off for subsequent manual application on intended cans, etc. Also a plurality of rollers, reels and arms have to be passed by the label web upon exchange thereof.

Furthermore, in certain cases, users of labelling machines have to manoeuvre the machine in a way that maybe not even is described in connection with the machine in question and for which it may take long time to carry out service.

Furthermore, there may be problems with known labelling machines in that the paper web is not arranged to pass straight through the machine since all parts of the machine that contact the paper web are not parallel. It is common that this makes that the bottom paper is not stretched around the dispenser edge along the entire width of the paper. In the worst case, this may cause that the labels do not come loose from the bottom paper and continue out onto the applicator, but that they instead follow the bottom paper around the dispenser edge.

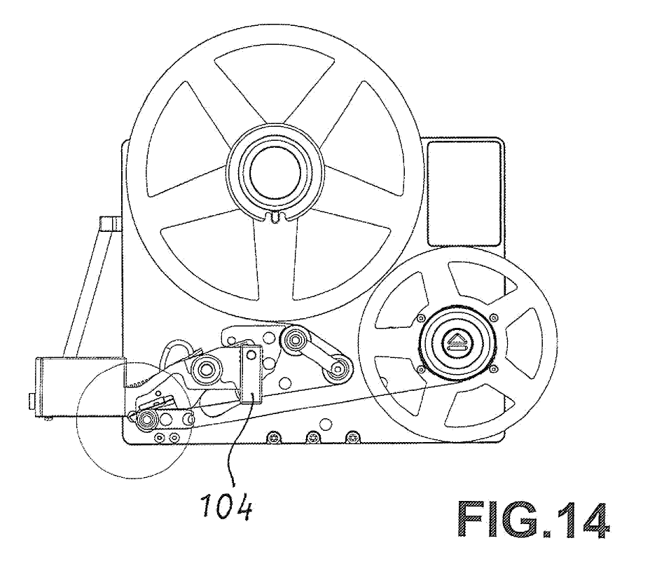

U.S. 2005271441 A1 and WO 2006 042088 A1 show a printer for labels and where a write head (518) is arranged pivotably mounted on a shaft (518). A sensor (736) is also arranged. See FIG. 14.

However, this does not mean that the invention is obtained by combining the shown known, since interspaces between labels according to the preamble of claim 1 are sensed. This has little to do with a split sensor that not has been shown to be previously known.

Thus, the main object of the present invention is primarily to solve, among others, the above-mentioned problems easily and efficiently.

Said object is attained by means of a device according to the present invention that essentially is characterized in that the sensor is partible, and that one part of the sensor, the transmitter or the receiver, is arranged to follow the write head when the same is moved in order to be opened and closed, respectively.

The invention and the machine around the same is described below in the form of a number of preferred embodiment examples, reference being made to the accompanying drawings, wherein

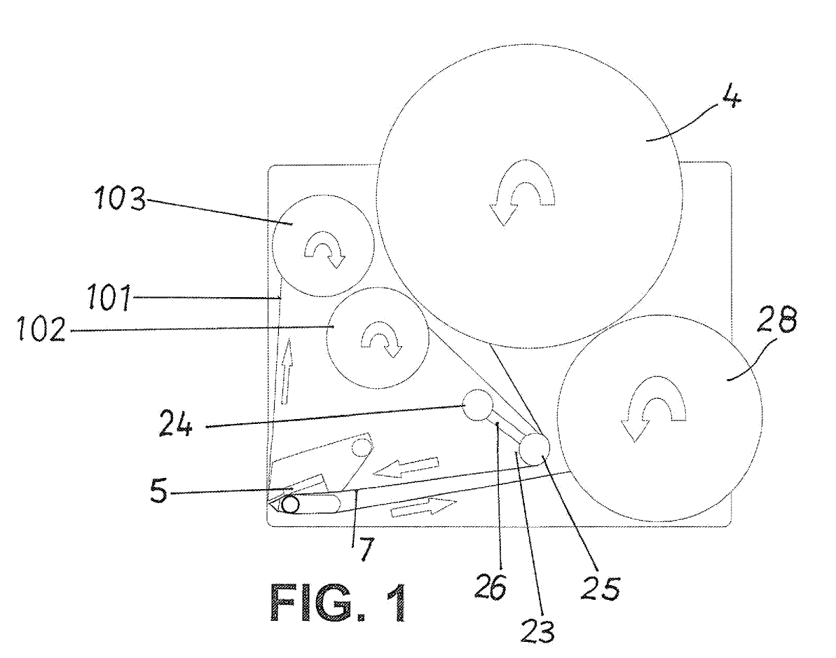

FIG. 1 shows schematically the invention applied to a machine for a label web of partible type,

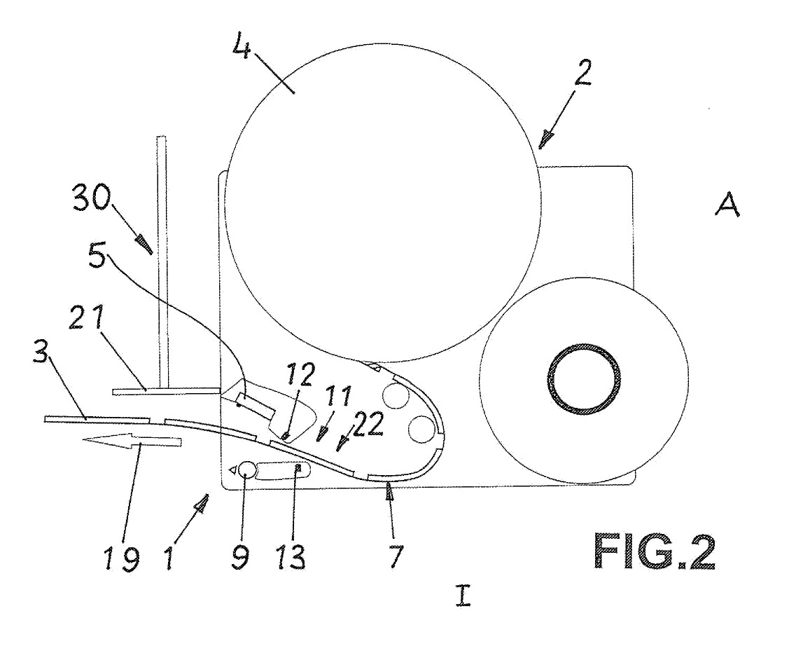

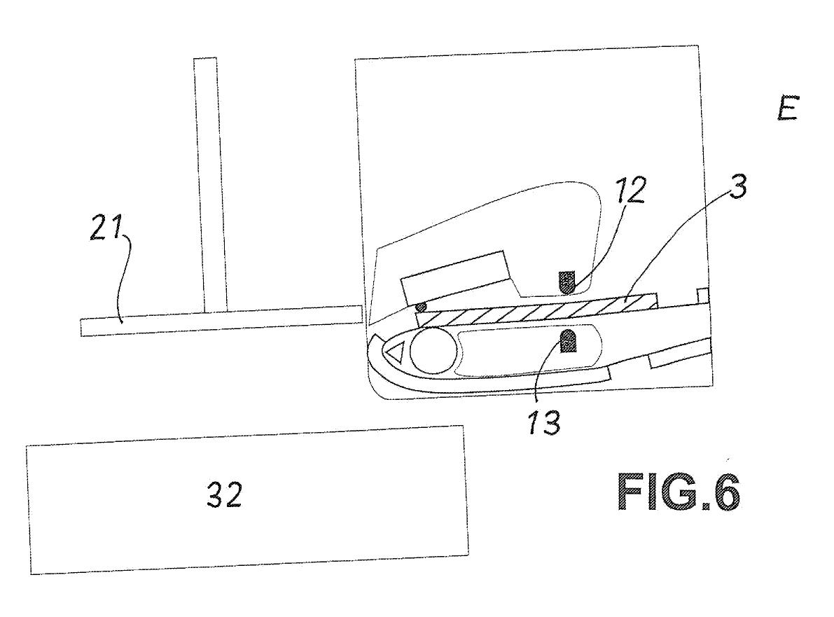

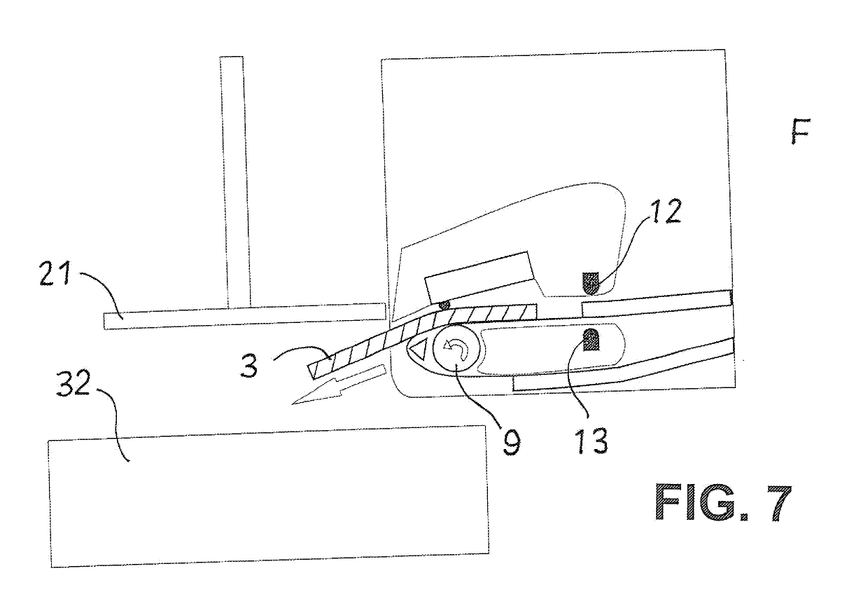

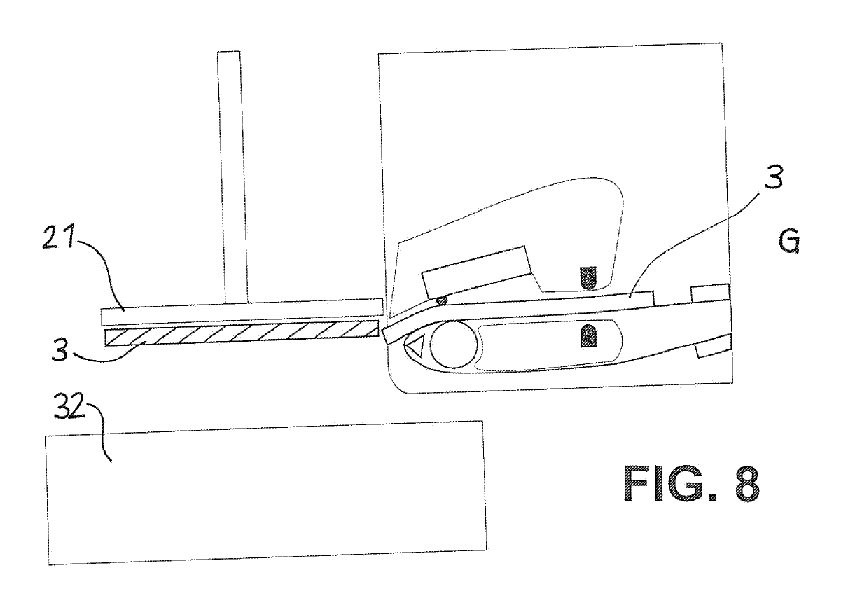

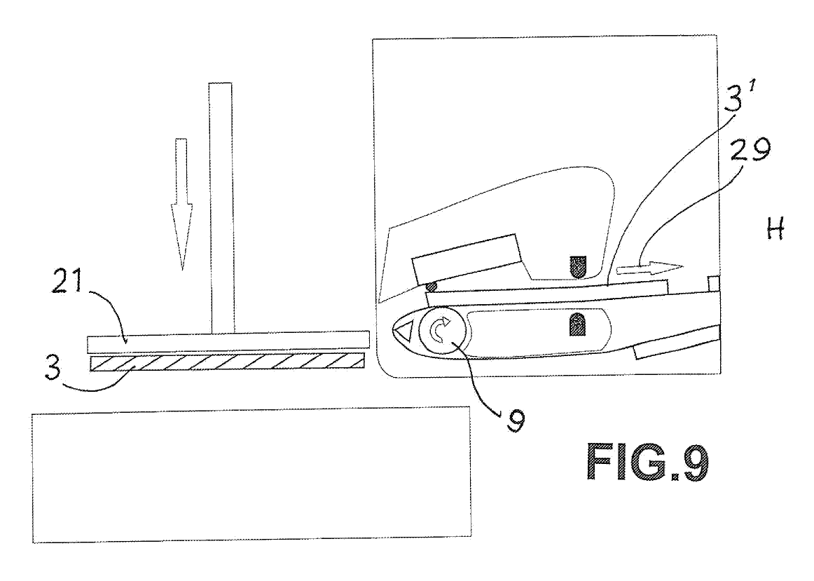

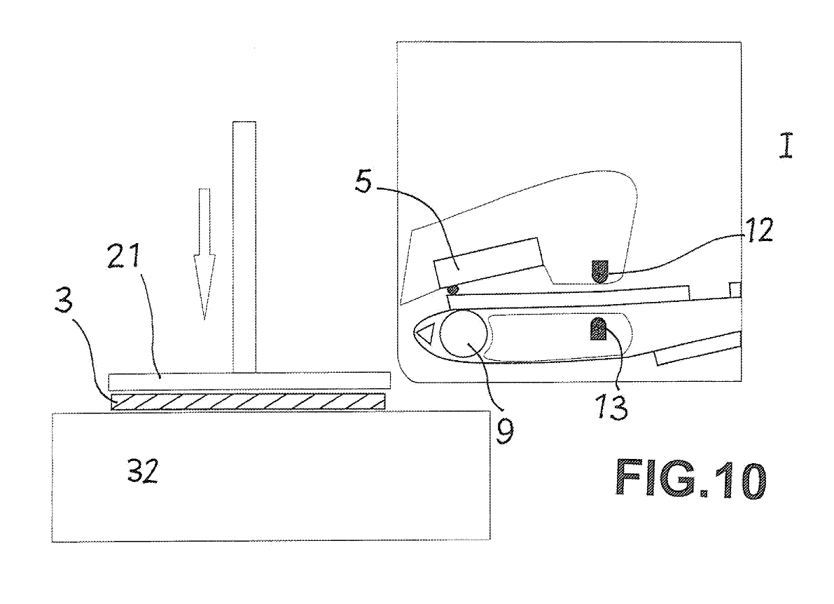

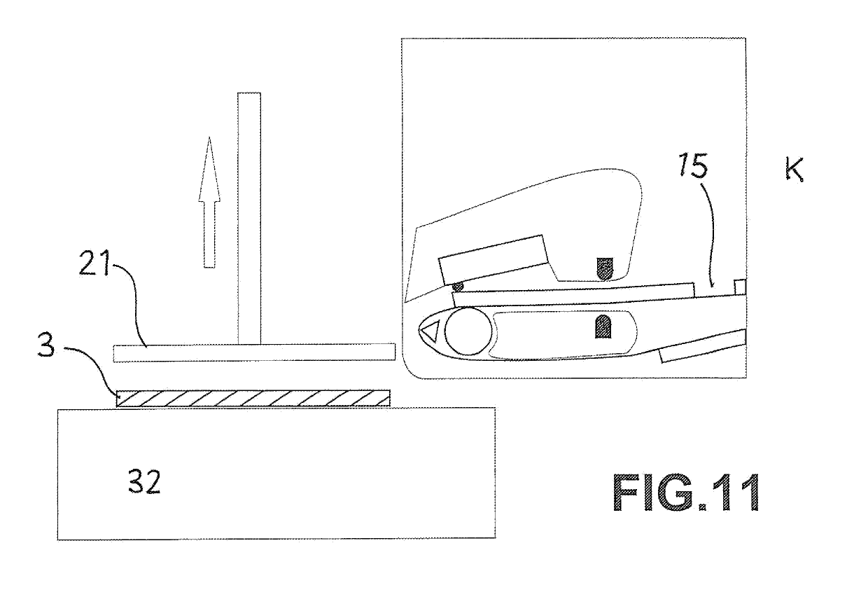

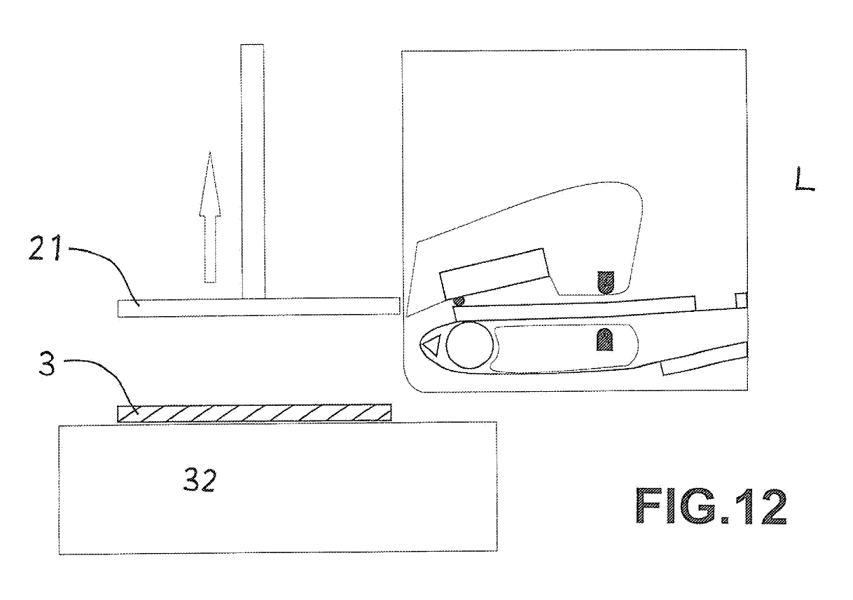

FIGS. 2-12 show different steps for the label output from a machine for a composed label web,

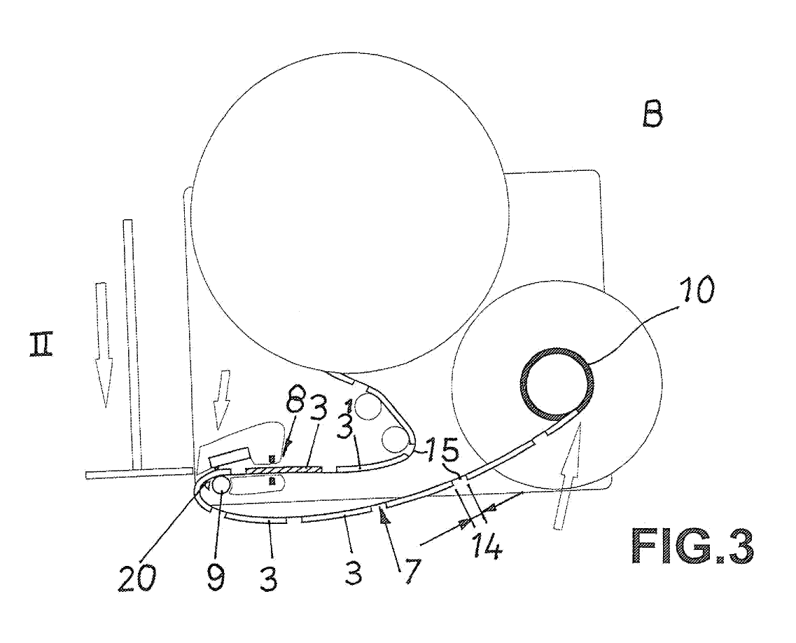

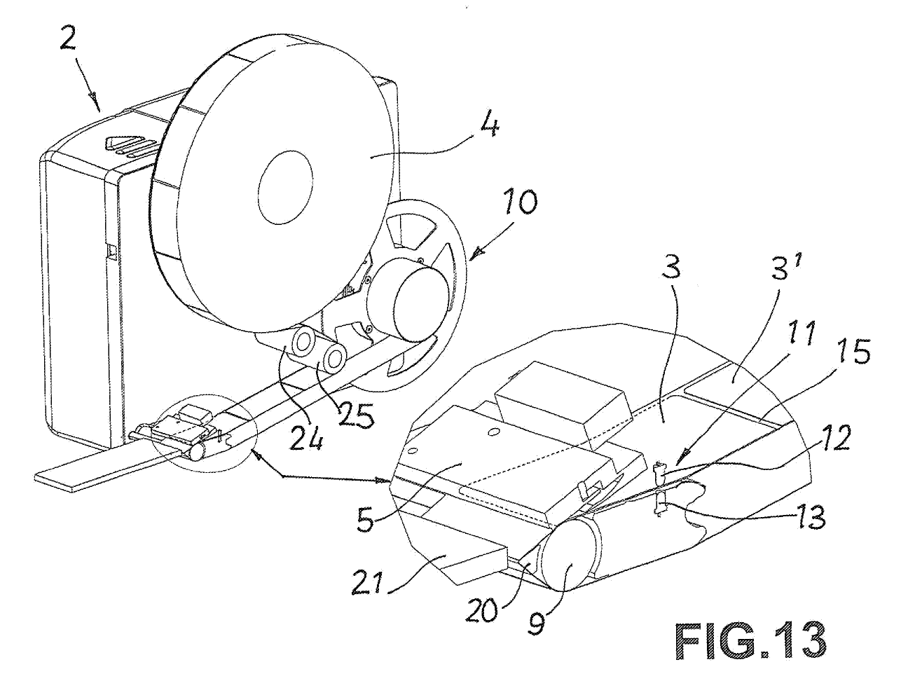

FIGS. 3-14 show the machine and the label pulling of such a machine,

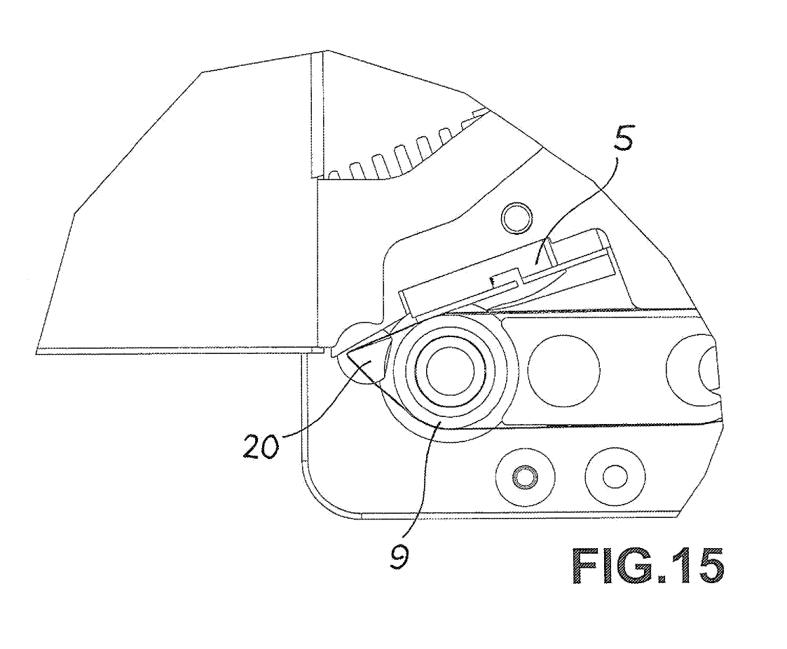

FIG. 15 shows the driving of a web,

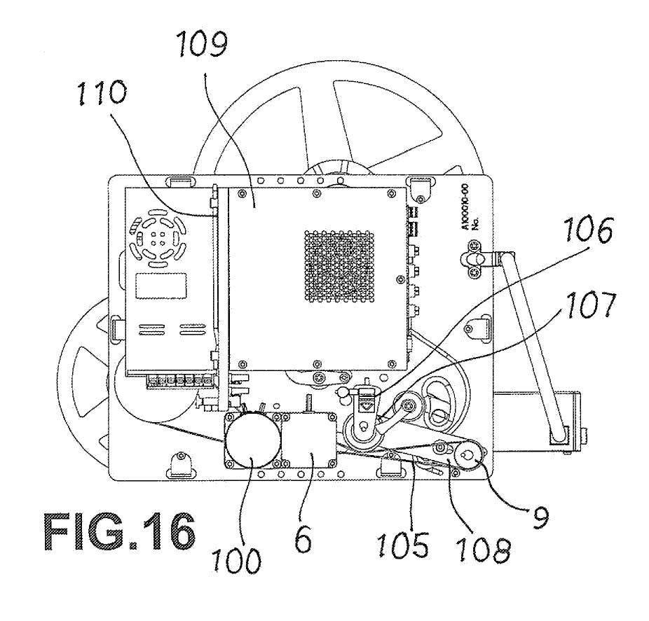

FIG. 16 shows a driver arrangement for the machine at the side thereof facing away,

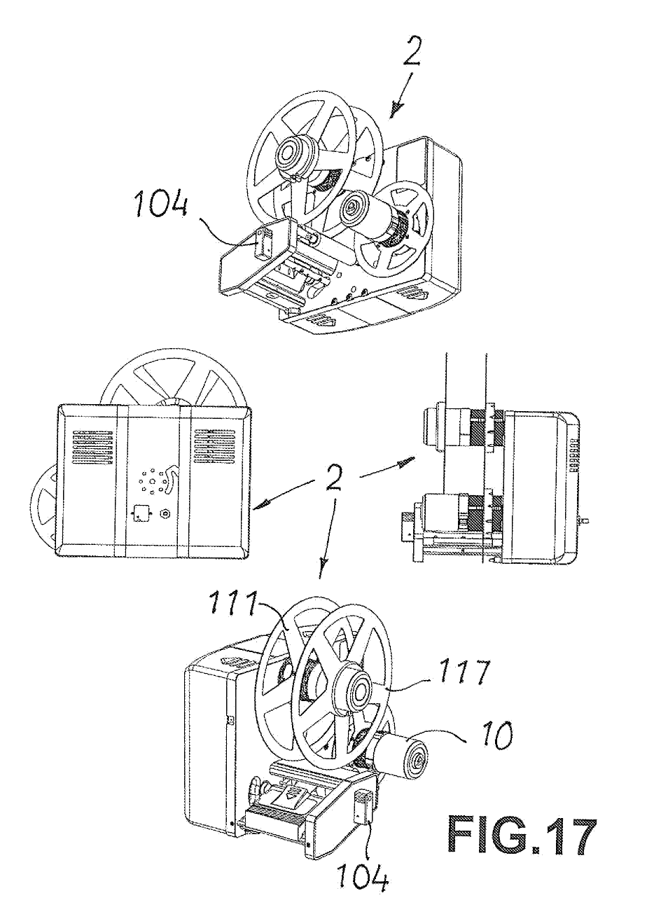

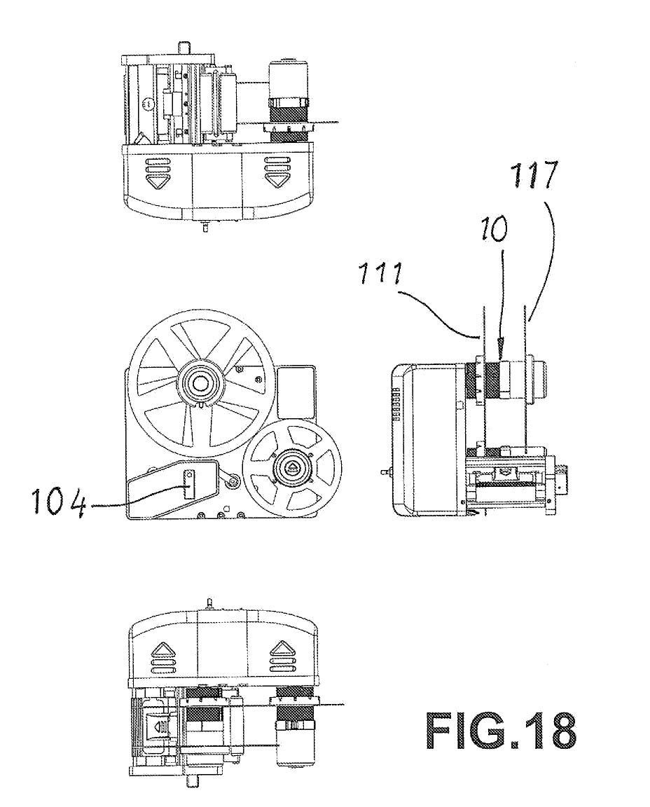

FIGS. 17-18 show different views of the machine, and

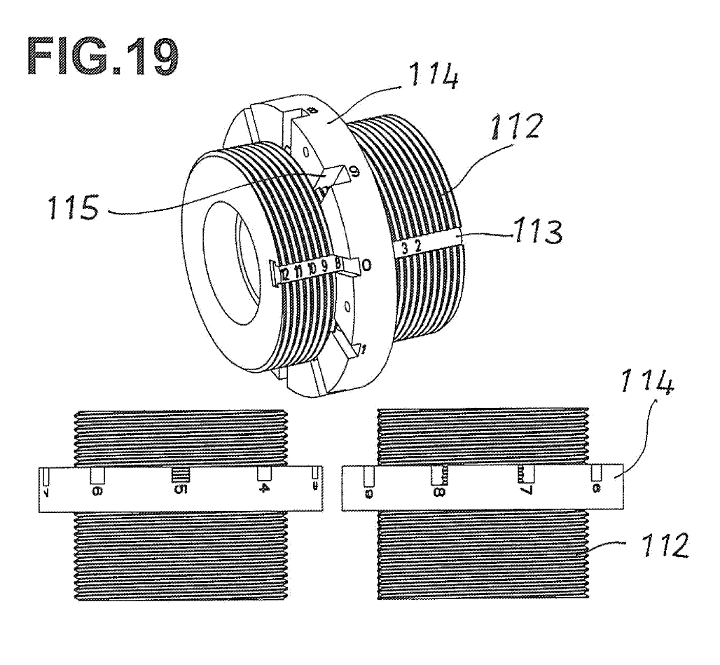

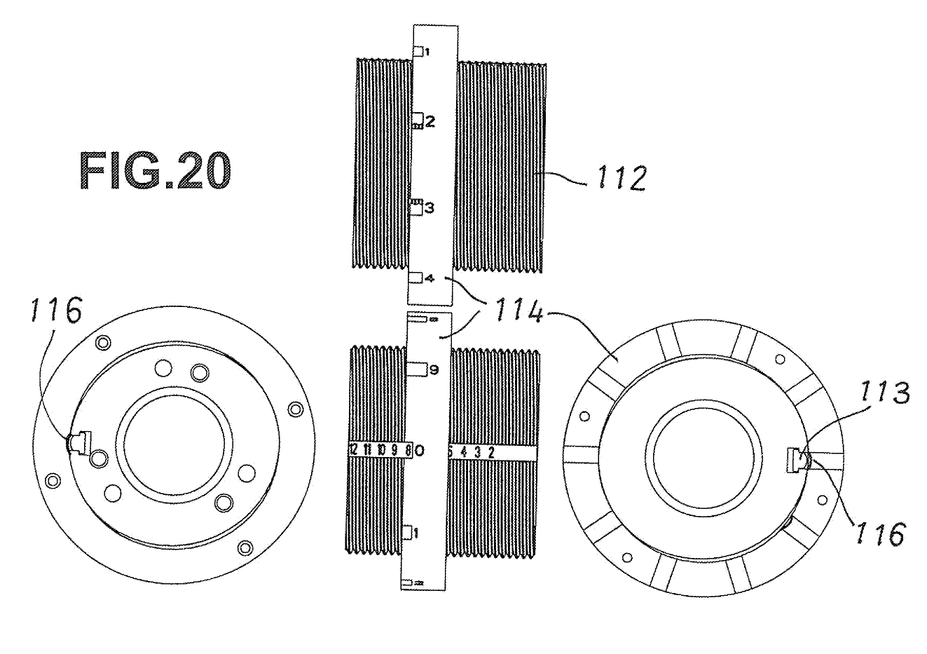

FIGS. 19-20 show means for centring a label reel on a storage shaft.

### GENERAL INTRODUCTION

The invention is intended to be applied to a machine that primarily is arranged to automatically print and apply self-adhesive labels on different types of products that, for instance, are transported on conveyor belts and is based on direct thermal technology, which means that the labels used change colour when they are exposed to strong heat. This power is utilized for providing a printout. For generating the heat, a so-called write head is used including a number of small heating elements. The write head lies pressed against the upperside of the labels and provides a printout by quick local heating and cooling. The underside of the label web is pressed by the write head against a rubber roller, called drive platen. The drive platen drives the paper web through the machine. The labels are glued consecutively on a glossy paper, which in turn is reeled up around a paper reel. After the labels have got the printout thereof, come loose from the glossy paper called “bottom paper”, and have been applied to the product, the bottom paper is reeled up on a second reel. Said reel, only having reeled on bottom paper, is discarded when the label reel is empty and consumed.

The label comes loose from the bottom paper by the fact that the label web passes a sharp edge, called dispenser edge. The bottom paper is forced to follow around the edge since the bottom paper reel pulls slightly in the bottom paper, but the label, which is glued to the bottom paper, continues instead out onto the applicator.

In order to apply the labels on the product, an applicator may be used. This may look in many ways. One of the simplest is a plate, called applicator plate, that is attached to a linear unit. When the label has come loose from the bottom paper, it continues out onto the applicator plate. Next, the linear unit brings the applicator plate up to the product where the label sticks, thanks to the glue thereof. During the transportation up to the product, the upperside of the label is secured to the applicator plate by means of, e.g., a negative pressure in the applicator plate. Now, the linear unit returns to the initial position thereof and the machine is ready for a new application.

The machine is controlled by the user via, e.g., a touch screen present adjacent to the machine. From the same, the user can, for instance, select which type of product the machine should mark or get guidance upon paper exchange.

### Reeling up of Media

It is important that the bottom paper is reeled up by the correct force. If too a great force is utilized, the friction between the paper web and the drive platen is overcome and the printout is distorted. If too a small force is utilized, the bottom paper is not stretched sufficiently around the dispenser edge, which increases the risk of the label not coming loose from the bottom paper. The bottom paper according to the present invention passes no rollers or shafts between the drive platen and the bottom paper reel. Normally, there is a risk that this solution brings about that the bottom paper not quite have the time to be strained up when the drive platen starts, because of the mass inertia of the bottom paper reel. Then, a temporary slack of the bottom paper is created that may lead to the label not coming loose from the bottom paper, which results in an abortive dispensing. To avoid this problem, it is selected to start a printout with the beginning of the label placed approx. 15 mm ahead of the dispenser edge. In this way, the bottom paper has time to, over this distance, be strained up, and the risk of an abortive dispensing is eliminated.

In order to provide a satisfying force in the bottom paper, a brushless DC-motor is used to drive the bottom paper reel. The current conducted through a DC-motor is proportional to the driving torque of the motor. By measuring the diameter of the paper reel in question, and based on this information control the current applied to a DC-motor 100, a constant force in the bottom paper can be provided. Having stored information about the width of the label, furthermore a constant tension can be provided in the bottom paper. This is suitable since the friction between the bottom paper and the drive platen is proportional to the width of the bottom paper. There is only information about the width of the label, not about the one of the bottom paper, but these widths are usually relatively uniform, since too a wide bottom paper entails an unnecessary cost.

According to the invention, one prints on heat-sensitive labels, which normally is called “direct thermal”-technology. A disadvantage of this technology is historically that the labels are sensitive to sunlight and heat. The most common solution of this problem is to use a heat-sensitive film that usually is called “ribbon”. Normally, the ribbon 101 as well as the labels are reeled up around a board reel 102. The ribbon passes together with the labels through the printer along the upperside of the labels. When the write head heats the ribbon, colour is released from the ribbon and instead sticks to the label. After the ribbon has passed the printer, it is reeled up on a second shaft 103.

The handling of the ribbon is usually carried out by the fact that the winding-off shaft for the ribbon is provided with a mechanical brake having an adjustable brake torque. The reeling up of the ribbon is normally carried out by the fact that a stepping motor is coupled via a mechanical coupling to a reeling shaft. In this way, a constant torque of the shaft is provided, but a force in the ribbon varies with the diameter of the ribbon reel.

According to the invention, precisely the same method to handle the ribbon as to handle the label web and the bottom paper is utilized. This means that a separate brushless DC-motor is used to reel up the used ribbon by a suitable torque. Just as for the bottom paper, the force in the ribbon can be controlled. As long as the width of the ribbon is the same as of the labels, compensation for the ribbon width can also be used.

### Automatic Machine Adjustment

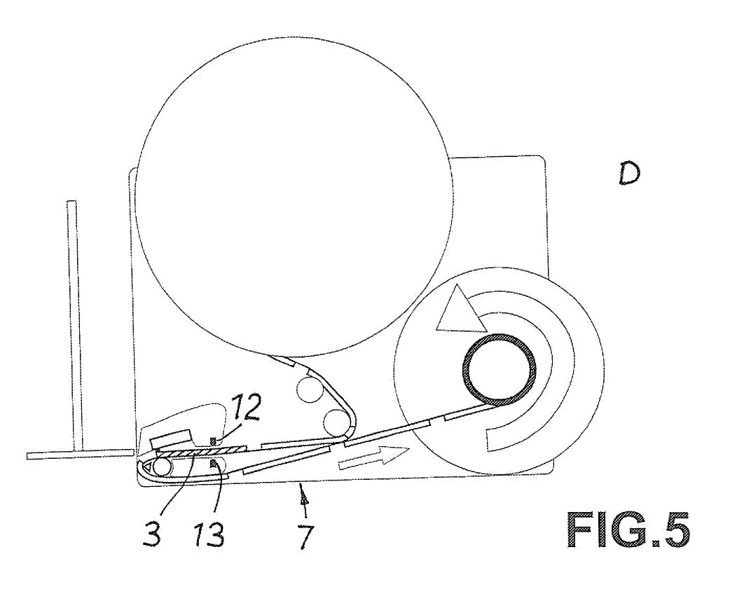

In order for the machine to be ready to work, the following conditions have to be met: Refer to, e.g., FIG. 5.
The sensor that senses the interspace between the labels should be calibrated according to the active labels. This sensor is normally called media sensor.
The label web should be located in a known position where printout can be started.
The bottom paper should be stretched.
The applicator should be free from unknown labels.

Upon turning on of the machine or after exchange of label reel, the above items have to be guaranteed before use. This is normally done in a known way in the following manner:
That the media sensor is calibrated is not at all normally controlled. The user may at any time carry out an adjustment command. This is normally done from an external PC.
The location of the label web is normally guaranteed by the fact that the user manually triggers the machine to print a number of labels until the labels seem to lie correct.
The bottom paper is normally stretched in connection with the user printing a number of test labels.
When the test printings are made and the bottom paper is stretched, normally there have landed a number of labels on the applicator plate.

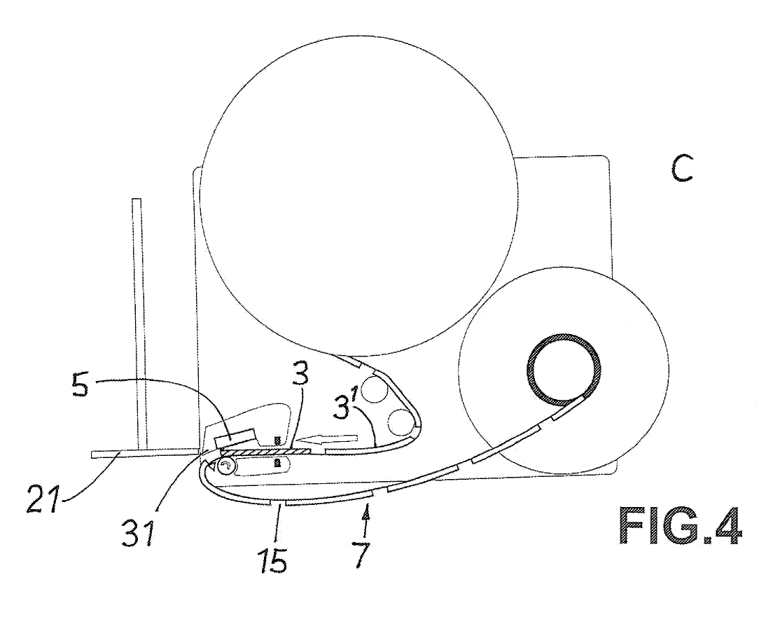

According to the present invention, said items are solved in the following way:
Upon turning on of the machine or when the user has exchanged the paper reel in the machine, an adjustment function is automatically invoked that calibrates the media sensor.
After the media sensor is calibrated according to the paper in question, the machine automatically finds next label and sets the label web in printout mode. Refer to FIG. 4.
During the two first phases, the reeling motor is not used, which means that the bottom paper is not stretched during the adjustment process. This results in that the labels do not come loose from the bottom paper but instead are reeled up together with the bottom paper. When the adjustment process during the two first phases is ready, the reeling motor is started and the bottom paper is stretched up. Refer to FIG. 5.
Since the bottom paper is not stretched during the two first phases when the machine feeds the paper web through the machine, no labels come loose from the bottom paper and no labels can land on the applicator. Therefore, this is no problem.

When the user is to exchange paper in the machine, this is done by the fact that the user turns a handle 104. See FIGS. 14 and 17. The handle takes away the write head from the paper web in such a way that the paper web is released. When the paper has been exchanged, the user turns back the handle. Then, the machine will automatically be adjusted for use. The touch screen shows that adjustment is in progress. When the adjustment is ready, it only remains a pressing on the touch screen in order to allow putting the machine into operation.

### Service

Normal wearing parts of label application machines are: Refer to FIG. 16.
Write head 5.
Drive platen 9.
Driving belt 105 between the drive platen 9 and the driving motor 6.

The machine according to the present invention is constructed in such a way that the drive platen and the driving belt should be very easy to exchange. This has been accomplished by the fact that the functionality is coupled to the handle that is used for lifting off the write head from the drive platen. By disengaging a catch 106, said handle 104 can be turned into a service position. This leads to the following consequences:
A deflection wheel 107 for the driving belt 105 is lifted off from the driving belt 105 so that the strap easily can be loosened and exchanged.
A retaining plate 108 is pushed away from the drive platen 9 so that the platen manually can be pulled out of the machine and be exchanged.
When the handle 104 is placed in the service position, then the write head 5 is in the raised position in spite of the handle being turned approx. 50° further upon service than upon normal raising of the write head.

This construction solution makes it possible to exchange essential service parts in the machine in an extremely short time and in such a way minimize the service costs. The experience indicates also that the electronics box 109 may need to be replaced, even if this is not counted as a normal wearing part. In order to make it easy to exchange the electronics box, the electronics box has been constructed in such a way that all internal connections to and from the electronics box can be made via a multipole slot connector. In addition, no tools are [symbol] 110 is used that clamps the box. The result is that the box can be loosened by a simple hand grip without tools.

Processing after Mounting

A common problem in the construction of labelling machines is that the paper web does not run straight through the machine. In order to minimize this problem, the machine is now constructed around a welded framing that after the welding is machined in an automatic cutter where all bearing seats and essential mounting surfaces are machined.

The machine is constructed in such a way that the paper web upon threading is inserted between the drive platen and the write head from behind. Otherwise, it is common that the paper is inserted from the side of the machine and that the fastening device for the write head and the outer attachment, and the drive platen are interconnected with some type of handle.

In order to facilitate the threading of the paper web into the machine, the write head is lifted up relatively much from the drive platen so that it becomes easy to thread the paper web from behind. This means in turn that it is in principle impossible to use an optical standard reading fork. The machine is therefore equipped with a sensor in the form of a partible reading fork where the transmitter and the receiver are not mechanically interconnected. One part is fitted together with the write head and one part is fitted together with the drive platen. In this way, it becomes much easier to thread the paper web through the machine and simultaneously very good tolerances of all essential measures of the machine are obtained.

### Setting of Label Width

The present machine has properties for keeping the label web centred around the middle of the write head. This entails a number of advantages, such as that the media sensor can be fitted in the middle of the width of the write head.

However, this implies that some form of setting of the machine is required when a new label width is to be used. Since the machine can be mounted at several different angles, the label reel needs lateral supports in order to be held intact. Said supports consist of two round discs 111, 117 that are placed on each side of the label reel. The inner disc 111 has to be moved laterally when a new label width is to be used. This lateral displacement has been selected to be performable by letting the inner disc act as a large nut at the same time as the winding-off shaft is provided with an external thread 112. In addition to this, there is a spring-loaded scale 113 having the FIGS. 2 to 12 recessed in the axial direction along the external thread. In the holder 114 of the inner disc, which acts as a nut, there are ten recesses 115. The recesses have different depths and the FIGS. 0 to 9 are located next to a recess each. The pitch of the thread is 5 mm per turn. This means that when the inner disc is rotated 1/10 of a turn, the centre of the labels is moved 5/10=0,5 mm, which is the same as an alteration of 1 mm of the label width. The selection of the pitch of the thread and the two scales in combination with the differently deep recesses create the possibility of being able to read which label width the machine is set to. Individual millimetres are read on the nut. The figure located above the recessed scale in the winding-off shaft is the current figure. Simultaneously, tens millimetres can be read on the impressed scale. Here, it is the figure located closest to the nut that applies. The result is that a figure between 20 and 120 can be read. This figure corresponds to the label width that the machine is set to.

In addition to this, there are ten recesses 116 in the internal thread of the nut. When the spring-loaded impressed scale in the winding-off shaft passes an impression in the thread of the nut, the scale is pressed into the recess and creates a fixation of the nut and thereby the inner disc. This fixation is easily overcome manually but is simultaneously sufficiently great to prevent the disc from rotating spontaneously after the setting is ready.

### Specified Description

A device 1 of a machine 2, which is arranged for outputting self-adhesive labels 3 from a reel 4, and which machine 2 comprises a write head 5 as well as drive means 6 to drive a label web 7, with the write head 5 movably mounted for widening a formed gap 8 through the machine 2 in order to allow pulling of the label web 7 between the write head 5 and a drive platen 9 to a reeling reel 10, is shown in the drawings. A sensor 11 formed of a transmitter 12 and a receiver 13, and which is arranged to sense interspaces 14 at labels 3 carried in a row on the label web 7 by sensing the thickness differences of the label web 7 and of the labels thereof carried on a bottom paper web 15, is partible according to the present invention.

In that connection, one part 12 of the sensor is formed of a transmitter or a receiver arranged to follow the write head 5 when the same is actuated to move in order to be opened and closed, respectively. The other part 13 of the sensor 11 is, in that connection, preferably fixedly arranged in the machine 2, and thus consists of a receiver or a transmitter. The sensor 11 formed of an IR-type, laser type, ultrasound type or another type of sensor, has one part 12 thereof movably arranged. More precisely, this movable sensor part 12 is turnably mounted or displaceable together with the write head 5 to a pulling position 1 for a label web 7, the open position thereof, and the sensor 11 is furthermore arranged to be calibrated automatically when the write head 5 is brought back to the original position 11 thereof, the closed position thereof.

Said IR-transmitter, 12 or 13, is arranged to be freely controlled by control electronics in the machine 2. In that connection, the IR-receiver has two sensing levels, the control electronics being arranged to determine if the received signal is higher or lower than two predetermined levels.

The strength of said transmitted signal is arranged to be variable at the same time as monitoring of the two reception levels is carried out.

Furthermore, the machine's 2 feeding of the label web 7 is arranged to go on until a fixed length of paper 15 has been fed through the machine 2 or until a higher receiver level has been reached, e.g., that a thinner section of the label web 7 between two labels 3, 3¹ has been sensed, feeding of a drive roller 9 being arranged to go on until an interspace 14 between pair-wise labels 3, 3¹ is detected by the fact that the lower receiver level is reached. The machine 2 is arranged to, after calibration of the sensor 11, place the dot row by the sensor parts 12, 13 in the beginning of a label 3, as seen in the feeding direction 19 of the label web 7. In doing so, the drive platen 9 is suitably situated ahead of the area of a dispenser edge 20 around which the label web 7 is arranged to extend, as seen in the feeding direction 19 of the web, and that said drive platen 9 is formed of a rubber roller arranged to be driven by a stepping motor 6. Possibly, the drive platen 9 could be driven by a brushless DC-motor, but such a motor is more expensive and not as exact as a stepping motor.

The respective label 3 is, after transfer from the machine 2 to an operating applicator plate 21 preferably arranged in the area in front of the machine, efficiently secured thereon by means of vacuum on the same.

In order to further, among other things, facilitate threading of a new label web into the machine 2 and past the forming gap 22 thereof at the interspace between the sensor parts 12, 13, there is arranged a springing reel mechanism 23. Said reel mechanism 23, which is formed of pair-wise freely rotatable reels 24, 25 on a rack arm 26, is arranged in an interspace 27 between the write head 5 of the machine 2 and a storage reel 4 for the labels 3 and the label web 7 thereof. In that connection, the label web 7, which is reelable on a reeling storage reel 28, is also arranged drivable in a direction 29 opposite the intended output direction 19. The applicator 30 is arranged to, by the applicator plate 21 thereof, suitably work at the same time as the label web 7 is driven. Also manual application of output labels can be applied by the invention.

A profile 31, which is arranged to clamp the write head 5, is utilized preferably for efficiently and reliably breaking loose the label 3 from the bottom paper web 15, of which a label web 7 together with all labels 3, 3¹ . . . is formed, after the label web 7 in question including the label 3 in question is output to an applicator plate 21 in question, by which said label 3 is arranged to be applied in place, on the intended objects 32.

Below, a functional description of the machine 2 and the different parts thereof follows:
A. The handle of the machine is set in open position, which entails that the write head and the applicator are raised in such a way that a new paper can be threaded through the machine.
B. The bottom paper is attached on the reeling shaft by means of clips that clamp the bottom paper. After this is done, the handle of the machine is set in closed position, which entails that the write head and the applicator are lowered into the working position.
C. Now, the machine starts to calibrate the media sensor. The media sensor consists of an IR-transmitter and an IR-receiver. The transmitter is controlled by the control electronics in the machine. The receiver has two sensing levels. Accordingly, the control electronics can be informed if the received signal is higher or lower than two fixed levels. The machine starts with varying the strength of the transmitted signal, which entails that the lower of the two reception levels has been reached but not the higher one. Now, the machine selects this strength of the transmitter and starts simultaneously to feed paper through the machine. This is done until a fixed length of paper has been fed through the machine or until also the higher receiver level has been reached. If the latter occurs, the machine has found a thinner section of the paper/media. Then, the machine stops at this part and makes a new setting of the transmitting strength in such a way that once again only the lower receiver level has been reached. Simultaneously, the transmitting strength that is required for both receiver levels to be reached is stored as “interspace strength”.

The machine starts again to feed paper/media. When the predetermined feeding length has been reached, the transmitter strength that was stored as “the interspace strength” is used. The machine can now detect an interspace between two labels by the fact that the lower receiver level is reached. The prerequisite for this is, accordingly, that the lower receiver level has not been reached for the part of the paper/media that contains a label. When the sensor is calibrated by having selected the correct transmitter strength, the machine places the label in such a way that the dot row is precisely in the beginning of the label.
D. When the sensor is calibrated and the label is ready, the bottom paper reel starts in such a way that the bottom paper is stretched. This is not done until now, since the labels that are fed through the machine during the calibration have followed the bottom paper around the dispenser edge, and therefore have not come loose and been output onto the applicator plate. If very long labels are used, it may also come into question to let the bottom paper reel rotate slowly during the calibration to prevent the bottom paper from forming a too large hanging arch. However, the principle is still that the bottom paper should be held unstretched during the calibration. The machine is now entirely ready to be used. Now, to activate the machine, only a pressing on the touch screen is required.
E. The machine is ready to be started.
F. The machine is started and a label is on its way out onto the applicator plate. The bottom paper is now strained around the dispenser edge. This picture shows clearly the spacing of 15 mm between the dot row and the outer part of the dispenser edge. Over this distance, the bottom paper reel should have time to accelerate in such a way that the bottom paper has time to become stretched before the label has reached the dispenser edge.
G. The label is now placed on the applicator plate and it is kept in place by vacuum in the applicator plate.
H. At the same time as the applicator is started, the machine starts to move the label back to the original position thereof for printout. Since the backing is carried out during the application, there is no time wasted.
I. The label reaches the object to be marked and sticks by means of the glue thereof on the object.
K. The applicator starts the reversion thereof to the original position thereof.
L. The machine has accomplished an application cycle and is ready for a new cycle.

The nature and the function of the invention should have been understood with the aid of what has been described above and by means of the accompanying drawings, but the invention is naturally not limited to the embodiments described above and shown in the accompanying drawings. Modifications are feasible, particularly as for the nature of the different parts, or by using an equivalent technology, without departing from the protection area of the invention, such as it is defined in the claims.

1-7. (canceled)

8. A sensor for a machine for outputting self-adhesive labels from a reel, the machine including a drive mechanism for a label web and a write head movably mounted for widening a formed gap through the machine for pulling the label web between the write head and a drive platen to a reeling reel, the sensor comprising:
a transmitter and a receiver arranged to sense interspaces at labels carried consecutively on the label web by sensing thickness differences of the label web and of the labels thereof carried on a bottom paper web, wherein one of the transmitter and the receiver is arranged to follow the write head when the write head is opened or closed.

9. The sensor of claim 8, wherein the other one of the transmitter and the receiver is fixedly arranged in the machine.

10. The sensor of claim 8, wherein the transmitter and receiver are either an infrared type, a laser type, or an ultrasound type, and one of the transmitter and receiver is turnably mounted or displaceable with the write head.

11. The sensor of claim 8, wherein the sensor is calibrated automatically when the write head is closed.

12. The sensor of claim 11, wherein the transmitter is an infrared type and is arranged to be freely controlled by control electronics of the machine, the receiver is an infrared type and has two sensing levels, and the control electronics of the machine determines if a received signal is higher or lower than two predetermined levels.

13. The sensor of claim 12, wherein a strength of a signal transmitted by the transmitter is variable simultaneously with determining if the received signal is higher or lower than two predetermined levels.

14. The sensor of claim 13, wherein a higher predetermined level corresponds to a thinner section of the label web between two labels

14. The sensor of claim 12, wherein the machine is arranged to feed the label web until a fixed length has been fed through the machine or until a higher level has been determined, after which feeding of a drive roller continues until an interspace between pair-wise successive labels is detected by determining a lower level, and after calibration of the sensor, the sensor is arranged to place a dot row in a beginning of a label as seen in a feeding direction of the label web.

15. The sensor of claim 9, wherein the transmitter and receiver are either an infrared type, a laser type, or an ultrasound type, and one of the transmitter and receiver is turnably mounted or displaceable with the write head.

16. The sensor of claim 15, wherein the sensor is calibrated automatically when the write head is closed.

17. The sensor of claim 16, wherein the transmitter is an infrared type and is arranged to be freely controlled by control electronics of the machine, the receiver is an infrared type and has two sensing levels, and the control electronics of the machine determines if a received signal is higher or lower than two predetermined levels.

18. The sensor of claim 17, wherein a strength of a signal transmitted by the transmitter is variable simultaneously with determining if the received signal is higher or lower than two predetermined levels.

19. The sensor of claim 18, wherein a higher predetermined level corresponds to a thinner section of the label web between two labels

20. The sensor of claim 17, wherein the machine is arranged to feed the label web until a fixed length has been fed through the machine or until a higher level has been determined, after which feeding of a drive roller continues until an interspace between pair-wise successive labels is detected by determining a lower level, and after calibration of the sensor, the sensor is arranged to place a dot row in a beginning of a label as seen in a feeding direction of the label web.

21. The sensor of claim 9, wherein the sensor is calibrated automatically when the write head is closed.

22. The sensor of claim 21, wherein the transmitter is an infrared type and is arranged to be freely controlled by control electronics of the machine, the receiver is an infrared type and has two sensing levels, and the control electronics of the machine determines if a received signal is higher or lower than two predetermined levels.

23. The sensor of claim 22, wherein a strength of a signal transmitted by the transmitter is variable simultaneously with determining if the received signal is higher or lower than two predetermined levels.

24. The sensor of claim 23, wherein a higher predetermined level corresponds to a thinner section of the label web between two labels

25. The sensor of claim 22, wherein the machine is arranged to feed the label web until a fixed length has been fed through the machine or until a higher level has been determined, after which feeding of a drive roller continues until an interspace between pair-wise successive labels is detected by determining a lower level, and after calibration of the sensor, the sensor is arranged to place a dot row in a beginning of a label as seen in a feeding direction of the label web.
